(19) United States
(12) Patent Application Publication
(10) Pub. No.: US 2023/0031196 A1
(43) Pub. Date: Feb. 2, 2023

(54) PHOTOVOLTAIC SYSTEM CREATION

(71) Applicant: Markus GISLER, Niederbipp (CH)

(72) Inventor: Markus GISLER, Niederbipp (CH)

(21) Appl. No.: 17/791,617

(22) PCT Filed: Jan. 12, 2021
(86) PCT No.: PCT/EP2021/050498

§ 371 Date: Jul. 8, 2022

(30) Foreign Application Priority Data
Jan. 13, 2020 (CH) 00031/20

(51) Int. Cl. G06F 30/13; H02S 10/00; G06F 30/20

(52) U.S. Cl. CPC G06F 30/13; H02S 10/00; G06F 30/20; G06F 2113/04

(57) ABSTRACT

A method for creating a photovoltaic system comprising several interconnected solar panels. The method includes the steps of generating an image of an installation site of the photovoltaic system; receiving, from a user, image coordinates corresponding to points on the image; defining an installation area of the solar panels using the image coordinates; receiving site-specific data of the installation site and solar panel specification data of one or more types of solar panels; and generating a layout of the solar panels within the installation area using the installation area, the site-specific data, and solar panel specification data.

### FIELD OF THE INVENTION

The present invention relates to a method for creating a photovoltaic system comprising several interconnected solar panels, and a photovoltaic system created using the method. Specifically, the present invention relates to a method, a computer, and a computer program product for creating a photovoltaic system comprising several interconnected solar panels, and a photovoltaic system creating using the method.

### BACKGROUND OF THE INVENTION

Photovoltaic systems can range in size from small domestic systems installed on a building roof, to mid-sized commercial systems installed on or beside office buildings or factories, to large systems installed on dedicated land and which can cover large areas.

These photovoltaic systems comprise a number of solar panels. Additionally, a mounting system for mounting the solar panels is required. Also, for converting the DC electricity generated by the solar panels into AC electricity required to feed into a power grid or household appliances, an inverter is required.

Creating such photovoltaic systems requires technical expertise, much like creating wind-farms or other tightly integrated power generating systems. To aid in creating photovoltaic systems, photovoltaic systems engineers use known software tools, for example to calculate solar irradiation at a given latitude and longitude, or to predict solar paths of the Sun at a given latitude and longitude, such that a rough estimate of power production capabilities can be made. However, designing, planning, installing and commissioning such a system still requires great specialist knowledge in the fields of photovoltaic systems and still results in creating photovoltaic systems whose detailed performance is not known in advance and which must be optimized after installation. In the field of domestic photovoltaic systems for residential homes, for example, it still takes an engineer roughly half a day to design and plan a photovoltaic system. After installation and commissioning of the photovoltaic system, further time is often spent optimizing photovoltaic systems once they are in the field. For example, pyranometers or pyrheliometers are routinely used to assess the performance of photovoltaic systems. Once a photovoltaic system is deployed, however, only a limited amount of optimization can still be done, for example minor adjustments in the orientation of the solar panels, as some decisions made during design, for example the particular type of solar panels used, would simply be too cumbersome to alter after installation has already occurred.

### SUMMARY OF THE INVENTION

It is an object of this invention to provide a method for creating a photovoltaic system comprising several interconnected solar panels and a photovoltaic system created using the method, which method and system do not have at least some of the drawbacks of the prior art. Specifically, the present invention relates to a method, a computer, and a computer program product for creating a photovoltaic system comprising several interconnected solar panels, and a photovoltaic system creating using the method. Depending on the implementation of the invention, creating the photovoltaic system comprises one or more of: designing, planning, drafting, modelling, simulating, installing and commissioning the photovoltaic system.

According to the present invention, these objects are achieved through the features of the independent claims. In addition, further advantageous embodiments follow from the dependent claims and the description.

According to the present invention, the above-mentioned objects are particularly achieved by a method for creating a photovoltaic system comprising several interconnected solar panels.

The method comprising generating, by a processor, an image of an installation site of the photovoltaic system and displaying the image on a display. The method further comprises receiving, in the processor, from a user, image coordinates corresponding to points on the image. The method further comprises defining, in the processor, an installation area of the solar panels using the image coordinates. The method further comprises receiving, in the processor, site-specific data of the installation area and solar panel specification data of one or more types of solar panels. The method further comprises generating, in the processor, a solar panel layout of the solar panels within the installation area using the installation area, the site-specific data, and the solar panel specification data, the solar panel layout comprising one or more of: a position of each solar panel, a solar panel orientation of each solar panel and the type of each solar panel.

In a variation, the method further comprises creating the photovoltaic system using the generated solar panel layout.

In a variation, the method further comprises simulating, in the processor, the photovoltaic system using the solar panel layout and site-specific data.

In a variation, simulating the photovoltaic system comprises simulating one or more of: an installed capacity, an electrical production within a given time interval, and a relative electrical production.

In a variation, generating the solar panel layout comprises the processor using an analytic model. The processor uses the installation area, the site-specific data and the solar panel specification data as inputs to the analytic model to generate an optimal solar panel layout for maximizing a pre-determined criterion. The pre-determined criterion is one or more of: an installed capacity, an electrical production within a given time interval (e.g. within a given hour, day, month, season, or year), and a relative electrical production.

In a variation, simulating the photovoltaic system further comprises optimizing, in the processor, the photovoltaic system by iteratively first generating an adjusted solar panel layout. Secondly, the adjusted solar panel layout, until an optimum is reached in one or more of: an installed capacity, an electrical production within a given time interval, and a relative electrical production. The optimum is reached by adjusting parameters of the solar panel layout. For example, the position and/or the orientation of the solar panels can be adjusted. In another example, the adjustment comprises switching to a different type of solar panel.

In a variation, optimizing the solar panel layout comprises using a model which was trained using measurement data from previously created, real-world, photovoltaic systems.

In a variation, simulating the photovoltaic system further comprises receiving, in the processor, power usage data at the installation site. The power usage data comprises one or more of: a number of residents at the installation site and a number of kilowatt-hours of power used per year at the installation site. The processor then generates, using the power usage data and the solar panel layout, one or more of: a proportion of yearly power provided by the photovoltaic system, draw power representing the power drawn per year at the installation site from a power grid, and feed power representing the power fed per year into the power grid by the photovoltaic system.

In a variation, generating the solar panel layout comprises generating a mounting system for mounting each of the solar panels.

In a variation, the solar panel specification data comprises one or more of: type, dimensions, weight, model, maximum power, module efficiency, maximum power point voltage, maximum power point current, operating temperature, and mounting system compatibility data. Solar panel specification data enables an accurate creation of the photovoltaic system based on parameters of physical, real-world modules and further enables, among others, an accurate simulation of the photovoltaic system.

In a variation, generating an image of the installation site comprises generating a plan view of the installation site using geolocation data.

In a variation, generating the solar panel layout comprises calculating, in the processor, one or more pitches of one or more sections of the installation area. The pitches are the angles of the sections of the installation area. For example, if the installation area is a mono-pitched roof of a building, the pitch is the angle of the roof with respect to the horizontal. For an installation area covering a gabled roof, two or more sections of different pitches are calculated.

In a variation, generating the solar plan layout comprises calculating, in the processor, one or more of: safety margins of the installation area, wind load of the solar plan layout, snow load of the solar plan layout, and total weight of the solar plan layout.

In a variation, generating the solar plan layout further comprises generating an image of the solar panel layout. The image can be a 2D-image and/or a 3D-image of the solar panel layout.

In a variation, the image of the solar panel layout includes the mounting system. Additionally, surroundings can be included to provide a more realistic image. The surroundings include one or more of: the installation area, a landscape, buildings, structures, and flora.

In a variation, the site-specific data comprises one or more of: a geographic location of the installation site, solar irradiation data of the installation site; site orientation data of the installation site; topographic data of the installation site; an environment type of the installation site; a roof type of the building of the installation site; and a roof surface of the building of the installation site. The environment type includes, for example: lakeshore, large plateau, empty field, and urban. The roof type includes, for example: flat roof, mono-pitched, gabled, hipped, butterfly, and arched. The roof surface of the building of the installation site includes, for example: bitumen, gravel, green, and granulated. In addition to the above mentioned items, the site-specific data can comprise a height above sea level of the installation site, a height above ground of the installation area; solar paths at the installation site; and shadowed areas at the installation site.

In a variation, creating the photovoltaic system further comprises generating, in the processor, a list of components of the photovoltaic system comprising one or more of: a number of each type of solar panel, a list of components of the mounting system, an inverter type, DC cable types and AC cable lengths, and AC cable types and AC cable lengths.

In a variation, creating the photovoltaic system further comprises generating, in the processor, assembly instructions for the photovoltaic system at the installation site using the solar panel layout, the assembly instructions comprising a list of one or more of: a number of meters of guardrail required, a volume of materials to be transported to the installation site, a weight of materials to be transported to the installation site, a type of vehicle required for transportation to the installation site, required lifting gear, required ballast gear, required lightning protection, and required surge protection.

In addition to the method for creating the photovoltaic system, the present invention also relates to a photovoltaic system comprising several interconnected solar panels created according to the method as described herein.

In addition to the method for creating the photovoltaic system and the photovoltaic system created according to the method, the present invention also relates to a computer for creating a photovoltaic system, the computer comprising a processor configured to carry out the method as described herein.

In addition to the method for creating the photovoltaic system, the photovoltaic system created according to the method and the computer for creating a photovoltaic system, the present invention also relates to a computer program product comprising a non-transitory computer-readable medium having stored thereon computer program code configured to control a processor of a computer such that the computer performs the steps according to the method as described herein.

It is to be understood that both the foregoing general description and the following detailed description present embodiments and variations, and are intended to provide an overview or framework for understanding the nature and character of the disclosure. The accompanying drawings are included to provide a further understanding, and are incorporated into and constitute a part of this specification. The drawings illustrate various embodiments and variations, and together with the description serve to explain the principles and operation of the concepts disclosed.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1 shows a block diagram illustrating schematically a computer used for creating a photovoltaic system;

FIG. 2 shows a flow diagram illustrating a sequence of steps for creating a photovoltaic system;

FIG. 3 shows a flow diagram illustrating a sequence of steps for creating a photovoltaic system;

FIG. 4 shows a flow diagram illustrating a sequence of steps for creating a photovoltaic system;

FIG. 5 shows a block diagram illustrating schematically components of a photovoltaic system;

FIG. 6 shows a block diagram illustrating schematically components of a solar panel layout;

FIG. 7 shows an illustration of a plan view of an installation site with an installation area;

FIG. 8 shows an illustration of a plan view of an installation site with an installation area and a solar panel layout;

FIG. 9 shows a plot of electrical consumption at an installation site and energy production of a photovoltaic system in summer; and

FIG. 10 shows a plot of electrical consumption at an installation site and energy production of a photovoltaic system in winter.

### DESCRIPTION OF THE EMBODIMENTS

Reference will now be made in detail to certain embodiments and variations, examples of which are illustrated in the accompanying drawings, in which some, but not all features are shown. Indeed, embodiments and variations disclosed herein may be embodied in many different forms and should not be understood as limited to the embodiments and variations set forth herein; rather, these embodiments and variations are provided so that this disclosure will satisfy applicable legal requirements. Whenever possible, like reference numbers will be used to refer to like components or parts.

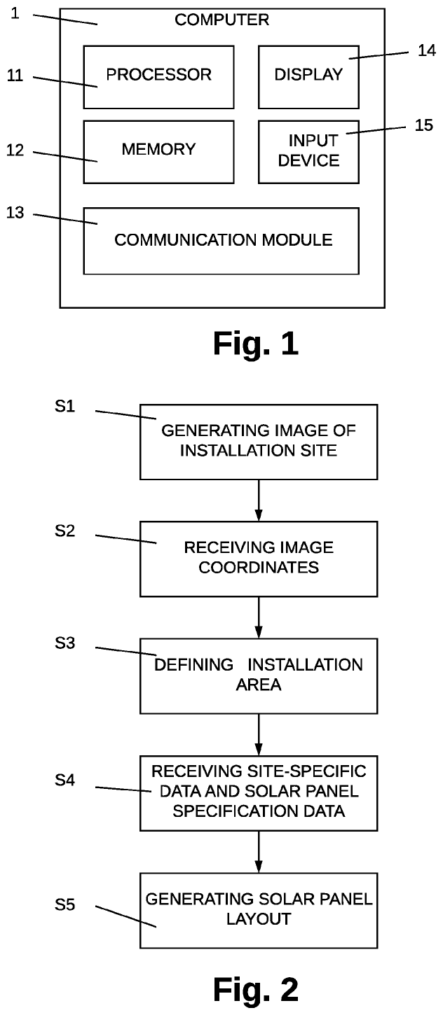

In FIG. 1, reference numeral 1 refers to a computer comprising one or more processors 11. The computer 1 can further include various components, such as a memory 12, a communication module 13, a display 14, and/or an input device 15. The components of the computer 1 can be connected to each other via a data connection mechanism, such that they can transmit and/or receive data.

The term data connection mechanism means a mechanism that facilitates data communication between two components, devices, systems, or other entities. The data connection mechanism can be wired, such as a cable or system bus. The data connection mechanism can also include wireless communication. The data connection mechanism can also include communication via networks, such as local area networks, mobile radio networks, and/or the Internet. The Internet includes, depending on the implementation, intermediary networks.

The processor 11 may comprise a system on a chip (SoC), a central processing unit (CPU), and/or other more specific processing units such as a graphical processing unit (GPU), application specific integrated circuits (ASICs), reprogrammable processing units such as field programmable gate arrays (FPGAs), as well as processing units specifically configured to accelerating certain applications, such as AI (Artificial Intelligence) Accelerators for accelerating neural network and/or machine learning processes.

The memory 12 comprises one or more volatile and or non-volatile storage components. The storage components may be removable and/or non-removable, and can also be integrated, in whole or in part with the processor 11. Examples of storage components include RAM (Random Access Memory), flash memory, hard disks, data memory, and/or other data stores. The memory 12 comprises a non-transitory computer-readable medium having stored thereon computer program code configured to control the processor 11, such that the computer 1 performs one or more steps and/or functions as described herein. Depending on the implementation of the invention, the computer program code is compiled or non-compiled program logic and/or machine code. As such, the computer 1 is configured to perform one or more steps and/or functions. The computer program code defines and/or is part of a discrete software application. One skilled in the art will understand, that the computer program code can also be distributed across a plurality of software applications. These software applications can each perform one or more steps and/or functions. The software applications can be implemented on across a plurality of devices, each performing one or more steps and/or functions as described herein.

In a variation, the computer program code is configured to further retrieve data and/or use functionality from one or more remote servers.

In a variation, the computer program code further provides interfaces, such as APIs, such that functionality and/or data of the computer 1 can be accessed for retrieval and/or modification remotely, such as via a client application or via a web browser. The client application or web browser can be executed on a user computing device of a user. The user computing device can be, for example, a desktop computer, laptop computer, tablet, or smart phone. The user computing device can perform one or more steps and/or functions as described herein. Accordingly, depending on the implementation of the invention, one or more steps and/or functions as described herein with reference to the computer 1 and/or the processor 11 can be executed on the user computing device of the user.

FIG. 2 illustrates a sequence of steps for creating a photovoltaic system 6. In the context of FIG. 2, creating the photovoltaic system 6 means designing the photovoltaic system 6. In particular, it means generating a solar panel layout 24 of the photovoltaic system 6. In step S1, the processor 11 generates an image 3 of an installation site 2. The installation site 3 is a location where a photovoltaic system 6 is to be created. The image 3 is a visual representation of the installation site 2. The image 3 can comprise a photograph, a map, a computer-generated render, and/or a model (2D or 3D).

In a variation, the image 3 generated by the processor 11 is displayed on a display 14 of the computer 1.

In a variation, the image 3 is a plan view of the installation site 2. The plan view is a top down view onto the installation site 2 and can be generated using aerial imagery, for example using satellite images and/or drone images.

In step S2, the processor 11 receives image coordinates 21. The image coordinates 21 are positions in the image 3. In particular, the image coordinates 21 are x-y positions in the displayed image 3, and the processor 11 uses the x-y positions to determine corresponding points in the image 3.

In a variation where the image 3 is a 3D image or model, the processor 11 uses the image coordinates 21 to determine points in the 3D image or model.

In a variation, a user, via an input device 15, selects image coordinates 21 on the image 3 which is rendered on the display 14. The image coordinates 21 are received in the processor 11.

In a variation, the image 3 is transmitted from the computer 1 to the user computing device and the image 3 is displayed on a display of the user computing device. The user selects image coordinates 21 on the image 3, which image coordinates 21 are transmitted by the user computing device to the computer 1.

In step S3, the processor 11 defines an installation area 22 using the image coordinates 21. The installation area 22 comprises one or more parts of the installation site 2 designated for solar panels 25. The installation area 22 is a two-dimensional or three-dimensional area of the installation site 2. The installation area 22 can be one single area or a number of non-contiguous areas.

In a variation, the image coordinates 21 are connected by straight line segments to generate one or more polygons, which polygons define the installation area 22. In particular, the image coordinates 21 are vertices of one or more polygons.

In a variation, a sequence in which the image coordinates 21 were selected is used to generate the one or more polygons. Preferably, line segments between each successively selected image coordinate 21 are generated during selection of the image coordinates 21. The processor 11 generates one or more polygons using the line segments.

In a variation, the processor 11 detects edges and/or lines in the image 3, and uses both the detected edges and/or lines as well as the image coordinates 21 for generating the installation area 22. In this way, generated line segments between image coordinates 21 can be realigned to detected edges in the image 3.

In a variation, the processor 11 uses the image coordinates 21 to define the installation area 22 by including in the installation area 22 a region around each of the image coordinates 21, depending on one or more of: a tolerance of the image coordinates 21, a radius around each image coordinate 21, features in the image 3 around the image coordinates 21, and regions of similar color, pattern, and/or structure in the image 3 around each image coordinate 21. This enables the processor 11 to efficiently and accurately define the installation area 22 according to properties of the installation site 2 present in the image 3. For example, if in the image 3 of the installation site 2 a roof of a building is depicted having a darker color relative to the surrounding area and the image coordinates 21 are near the corners of the roof, the processor 11 can define the installation area 22 to correspond to the roof using a tolerance in the precise position of the image coordinate 21 and by detecting the roof as region of similar color.

In a variation, a second set of image coordinates 21 is received by the processor. The second set of image coordinates 21 is used by the processor 11, in a similar manner as described above for the installation area 22, to define a restricted area 23. The restricted area 23 indicates an area not designated for solar panels 25. The restricted area 23 is defined as one or more polygons. If the restricted area 23 overlaps the installation area in whole or in part, the processor 11 can use the restricted area 23 to modify the installation area 22 such that the modified installation area 22 does not overlap the restricted area 23.

In step S4, the processor 11 receives site-specific data. The site-specific data comprises data relating to the installation site 2. The site-specific data comprises one or more of: a geographic location of the installation site 2 (e.g. latitude and longitude of the installation site 2), solar irradiation data, site orientation data of the installation site 2 (e.g. data relating to how the surface of the site is angled), topographic data of the installation site 2 (e.g. data relating to how the installation site 2 is shaped), an environment type of the installation site 2 (e.g. lakeshore, large plateau, empty field, and urban), whether a building or other type of structure is present on the installation, a roof type of a building of the installation site 2 (e.g. flat roof, mono-pitched, gabled, hipped, butterfly, and arched), a roof surface of the building of the installation site 2 (e.g. bitumen, gravel, green, or granulated), a height above sea level of the installation site 2, a height above ground of the installation area 22, whether the solar panels 25 are to be mounted flat or angled, solar paths at the installation site 2, and shadowed areas at the installation site 2. Solar irradiation data relates to the energy in Watts per square meter received at the Earth's surface from the Sun. The site-specific data comprises solar irradiation data interpolated from nearby meteorological measurement stations. Solar paths are the paths that the Sun takes across the sky relative to a given location. The solar paths change during the course of the year. Shadowed areas are those areas of the installation site 2 which lie in shadow during some or all times of the day, for some or all days of the year. The shadows can be cast by large-scale geographic features, such as the shape of the horizon from the position of the installation site 2. Other, more local features such as man-made and natural structures, for example buildings and trees, can also cast shadows over parts of the installation site 2. The site-specific data can be retrieved by the processor 11 from the memory 12, or from a remote server, for example from a geographic information server. The processor 11 further receives solar panel specification data of one or more types of solar panel 25. The solar panel specification data relates to the properties of solar panels 25, and comprises data such as a solar panel type 243, dimensions, weight, model, maximum power, module efficiency, maximum power point voltage, maximum power point current, operating temperature, and mounting system 62 compatibility data. The solar panel specification data can be retrieved by the processor 11 from the memory 12, or from the remote server. The solar panel specification data can be part of a library of solar panel data.

In step S5, the processor 11 generates a solar panel layout 24 of a plurality of solar panels 25 using the installation area 22, the site-specific data and the solar panel specification data. The solar panel layout 25 defines a position of each solar panel 25, an orientation of each solar panel 25, and a solar panel type 243 of each solar panel 25. The processor 11 generates the solar panel layout 24 such that it covers the installation area 22 densely and efficiently and such that the solar panels 25 are oriented towards the Sun.

In a variation, the processor 11 generates a solar panel layout 24 comprising one or more custom solar panels. These custom solar panels can have irregular dimensions and are particularly suitable for complex installation areas 22 which cannot be completely covered by standard rectangular solar panels of particular dimensions. In particular, building facades which have one or more restricted areas 23 not designated for solar panels 25, for example windows, doors, and/or balconies, can require custom solar panels to achieve a dense coverage of solar panels 25. For each custom solar panel, the processor 11 generates dimensions and solar panel type of the custom solar panel. The processor 11 can transmit solar panel layout 24 comprising the custom solar panels, the dimensions and the solar panel type of each custom solar panel to a production facility for manufacture of the custom solar panels.

In a variation, the processor 11 generates the solar panel layout 24 as a lattice. For example, if the solar panels 25 are rectangular, the processor 11 generates S5 the solar panel layout 24 as a straight stack tiling where edges of neighboring solar panels 25 line up. Alternately, the processor 11 can also generate other lattices, such as an offset lattice where a given row of solar panels 25 is shifted with respect to one or more of its neighboring rows such that not all edges of neighboring solar panels 25 line up.

In a variation, the processor 11 generates the solar panel layout 24 such that the solar panels 25 are set at an angle with respect to the installation area 22.

In a variation, the processor 11 generates the solar panel layout 24 such that shadows cast by solar panels 25 of the solar panel layout 25 onto other solar panels of the solar panel layout 25 are minimized. By minimizing the shadows cast the relative electrical production of the solar panel layout 24 can be increased.

In a variation, the user can constrain the generated solar panel layout 24 by providing to the processor 11 a set of constraints. For example, the constraints can limit the solar panel layout 24 to comprise a specific type of solar panel 25. The specific type of solar panel can be, for example, one or more of: solar panels attached to racks, rackless solar panels, solar shingles, solar tiles, solar roof panels, and solar glass. The constraints can also limit the range of angles that the solar panels 25 can have with respect to the ground or with respect to the installation area 22. In this variation, the processor 11 generates 11 the solar panel layout 24 further using the constraints.

In a variation, the processor 11 selects, using the solar panel layout 24, an inverter for converting the direct current electricity produced by the solar panel layout 24 into alternating current electricity appropriate for feeding into a power grid or into a building electrical system. The inverter is selected by the processor 11 from one or more inverters of an inverter specification dataset, which inverter specification dataset is either retrieved from memory 12 or received from a remote server. The inverter is selected by the processor using the type of solar panels 25 and the number of solar panels 25 of the solar panel layout 24, and the selected inverter is added to the solar panel layout 24.

In a variation, generating the solar panel layout 24 comprises generating a mounting system 62 for mounting of the solar panels 25. The mounting system 62 is used to secure the solar panels 25 at a particular position and/or orientation. The mounting system 62 can comprise rails, brackets, racks, and the like for fixing the solar panels 24 at a given position and at a given orientation 242.

In a variation, generating the solar panel layout 24 further comprises receiving, in the processor 11, a mounting system type. The processor 11 then generates the solar panel layout 24 using the mounting system type. In particular, the processor 11 generates the solar panel layout 24 comprising solar panels 25 which are compatible with the mounting system type. The mounting system types are one or more of: roof rack mount, flat roof rack mount, angled roof rack mount, façade mount, and ground mount.

In a variation, the mounting system 62 comprises a solar tracker which enables the solar panels 242 to change orientation 242 during the day to track the Sun.

In a variation, the processor 11 selects, using the solar panel layout 24, a battery 67 for storing electricity produced by the solar panel layout 24. The battery 67 is selected from a battery dataset which comprises battery specifications of one or more batteries 67. The selected battery 67 is added to the solar panel layout 24.

In a variation, the processor 11 generates, using the solar panel layout 24, cabling required. The cabling required may comprise cabling suitable for interconnecting the solar panels 25, as well as cabling suitable for connecting the solar panels 25 to the inverter, and cabling suitable for connecting the inverter to the building electrical system and/or the power grid. The cabling can comprise AC cables 64 and/or DC cables 63.

In a variation, the processor 11 generates, using the solar panel layout 24, additional components required for the safe installing and operating of the photovoltaic system 6, for example lightning protection 65 and/or surge protection 66.

In a variation, generating S5 the solar panel layout 24 comprises calculating one or more of: safety margins of the installation area 22 (e.g. zones at the edges of the installation area 22 which are not designated for solar panels 25), a wind load of the solar panel layout 24, a snow load of the solar panel layout 24, and a total weight of the solar panel layout 24. The safety margins ensure that the solar panel layout 24 does not abut the edge of the installation area 22, such that sufficient space is left for access (e.g. for installation, commissioning, and maintenance). The wind load of the solar panel layout 24 is calculated using the site-specific data to ensure that regulations on the maximum wind load are not exceeded. The snow load of the solar panel layout 24 is also calculated using the site-specific data to ensure that regulations on the maximum snow load are not exceeded. The total weight of the solar panel layout 24 is also calculated. If the installation area 22 is on a building or other support structure the total weight is used to ensure static loads are not exceeded.

In a variation, the processor 11 renders an image of the solar panel layout 24. The processor 11 can render the image of the solar panel layout 24 using the image 3 of the installation site. An output of the render can be a 2D image, or a 3D model.

In a variation, the processor 11 generates a solar panel report comprising the solar panel layout 24. The solar panel report is stored in the memory 12.

In a variation where the user is using the user computing device, the solar panel report is transmitted to the user computing device.

In a variation, the solar panel report is transmitted, by the processor 11, to a photovoltaic system warehouse.

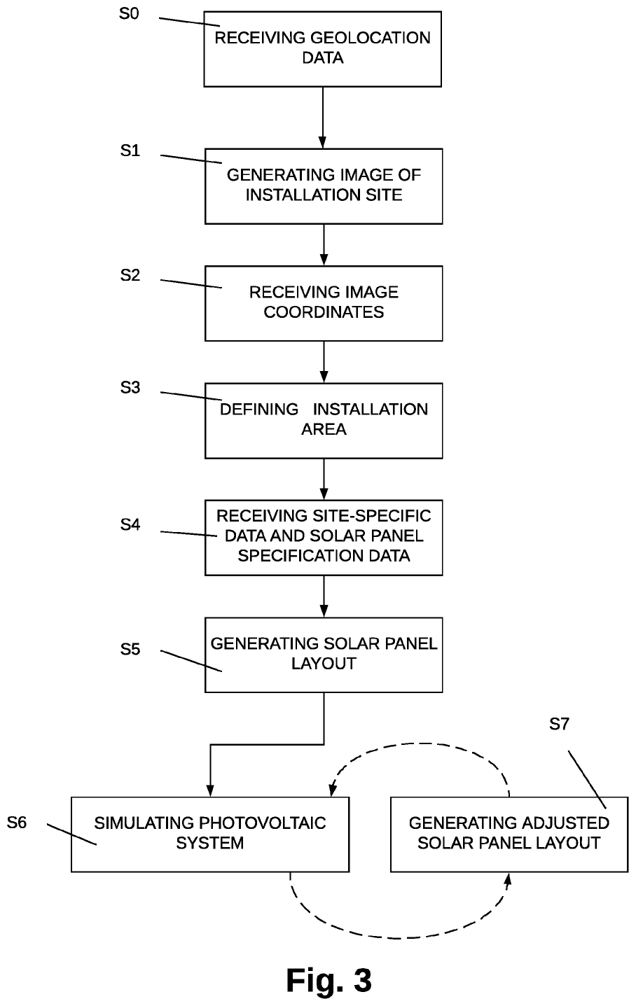

FIG. 3 shows a flow diagram illustrating a sequence of steps for creating the photovoltaic system 6. In the context of FIG. 3, creating the photovoltaic system means designing and simulating the photovoltaic system 6. Prior to step S1 which is described above an additional step S0 is shown. In step S0, generating the image 3 of an installation site 2 further comprises the processor 11 receiving geolocation data corresponding to the installation site 2. Geolocation data comprises an address (e.g. physical address, or IP address), GPS coordinates, or other data which enables an estimation of location (e.g. cell-phone signal data). The geolocation data can be received from the user via the input device 15. Alternately, if the invention is implemented using a user computing device in addition to the computer 1, the user inputs the geolocation data into the user computing device, which transmits the geolocation data to the processor 11. Additional steps S6 and S7 are also shown. In Step S6, the processor 11, using as an input the solar panel layout 24, simulates the photovoltaic system 6 to generate performance data relating to the electrical production of the photovoltaic system 6. In addition to the solar panel layout 24, the processor 11 also uses as an input the site-specific data for simulating the photovoltaic system 6. The simulation of the photovoltaic system 6 is particularly accurate because the solar panel layout 24 is generated using solar panel specification data of real solar panels 25, as opposed to ideal models of photovoltaic modules.

In a variation, the processor 11 simulates the photovoltaic system 6 by simulating an average year of solar irradiation at the installation site 23, using the site-specific data and the resulting electrical production of the photovoltaic system 6.

In a variation, for computational efficiency, the processor 11 simulates the photovoltaic system 6 by simulating one or more average days for each month of the year. The simulation has as an output the installed capacity, which is a measure of an energy output expressed in Watts of the photovoltaic system 6 when running at full-load, i.e. the peak energy output at midday in summer. Further outputs of the simulation include an electrical production at a given point in time, expressed in watts, or over a given time-interval, expressed in kilowatt hours. For example, the time-interval could be a number of minutes, hours, a number of days, a season, or an entire year. For example, the electrical production of the photovoltaic system 6 is output, by the processor, at every minute of an average day in summer. A further output of the simulation is a relative electrical production, which the electrical production relative to the installed capacity. If the solar panel layout 24 of the photovoltaic system 6 is not configured optimally, then the relative electrical production will be low in comparison with a photovoltaic system 6 in which the positions 241, orientations 242, and types 243 of solar panel 25 are optimal for the given installation site and operating conditions, as defined in the site-specific data.

In a variation, generating the solar panel layout 24 comprises the processor 11 using an analytical model. The processor uses the installation area, the site-specific data and the solar panel specification data as inputs to the analytical model to generate an optimal solar panel layout for maximizing pre-determined criteria. The predetermine criteria can be one or more of: installed capacity, electrical production in a given time-interval, and relative electrical production, which relates to a ratio between installed capacity and electrical production. The processor 11 can generate the solar panel layout 24 to maximize only one of the aforementioned criteria, for example the installed capacity, or the processor 11 can generate the solar panel layout 24 such that all criteria are considered, for example by maximizing a normalized and weighted sum of all criteria.

In an optional step S7, the processor 11, using the output of the simulation, generates an adjusted solar panel layout 24. The adjusted solar panel layout 24 comprises solar panels 25 with an adjusted position, orientation, and/or type. The processor 11 adjusts the solar panel layout 24 to improve the performance data. For example, the processor 11 can adjust the solar panel layout 24 to improve the electrical production. The adjusted solar panel layout 24 is then simulated again and the resulting performance data evaluated. This process of adjusting and simulating continues until an optimum in the performance data is reached. The resulting optimized solar panel layout 24 is then used to create the photovoltaic system 6.

In a variation, the processor 11 uses a model or method to optimize the solar panel layout 24. For example, Monte Carlo methods can be used to find an optimized solar panel layout 24.

In a variation, experimental data collected from previously created photovoltaic systems 6 is used by the processor 6 to optimize the solar panel layout 24. In particular, a neural network is used by the processor 11 to generate an optimized solar panel layout 24. The neural network is previously trained by using the solar panel layouts 24 of, and experimental data collected from, existing photovoltaic systems 6.

In a variation, the processor 11 receives power usage data relating to the power consumption at the installation site 2. The power usage data can comprise a number of residents at the installation site, which number of residents is used to generate an approximate power consumption. The power usage data can also comprise a number of kilowatt hours consumed at the installation 2 in a given time-interval, e.g. during a given day, month, or year. The power usage data can also comprise accurate power meter data collected by a power meter onsite at the installation site 2. The processor 11 then generates, using the power usage data and the solar panel layout 24, one or more of: a proportion of yearly power provided by the photovoltaic system 6, draw power representing the power drawn per year at the installation site 2 from a power grid, and feed power representing the power fed per year into the power grid by the photovoltaic system 6. The processor 11 can further determine whether the photovoltaic system 6 generates more electricity than the installation site 2 consumes during a given time-interval. The processor 11 can further determine which type of battery 67 the photovoltaic system 6 requires in order for the installation site 2 to be autonomous. In particular, the processor 11 determines a battery capacity of the battery 67 such that the photovoltaic system 6 in combination with the battery 67 can provide sufficient electrical energy during the year such that the installation site 2 does not need to draw electrical energy from the power grid. In some instances, the installation site 2 may not even be required to be connected to the power grid. A safety margin can be used by the processor 11 for calculating the battery capacity to ensure that sufficient electrical energy can be stored for time periods where the solar panels 25 generate little or no electricity.

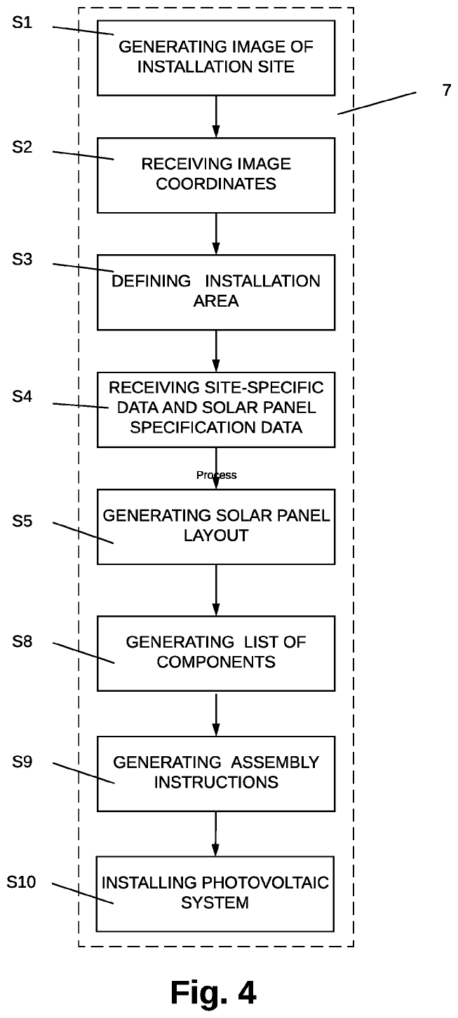

FIG. 4 shows a flow diagram illustrating a sequence of steps for creating the photovoltaic system 6. In the context of FIG. 4, creating the photovoltaic system 6 means designing, planning, and installing the photovoltaic system 6. Reference Numeral 7 refers to a sequence of Steps S1 to S10 for creating the photovoltaic system 6. In Step S8 the photovoltaic system is planned. In particular, the processor 11 takes as an input the generated solar panel layout 24, which generation is described in relation to FIG. 2 as described above, or the optimized solar panel layout 24 generated according to FIG. 3 as described above. In Step S8 the processor 11 generates a list of components of the photovoltaic system 6. The list of components comprises one or more of: a number of each type of solar panel 25, a list of components of the mounting system 62, an inverter type, a battery type, DC cable types and AC cable lengths, and AC cable types and AC cable lengths. The list of components is used to create the photovoltaic system 6. The list of components includes part of, or all, of the components required to create the photovoltaic system 6. The processor 11 quickly and efficiently generates the list of components using the solar panel layout 24 which enables a quick and reliable creation of the photovoltaic system 6.

In Step S9 the photovoltaic system 6 is planned further. In step S9, the processor 11 generates assembly instructions for the photovoltaic system 6 at the installation site 2 using the solar panel layout 24. The assembly instructions comprise a list of one or more of: a number of meters of guardrail required, volume of materials to be transported to the installation site 2, weight of materials to be transported to the installation site 2, type of vehicle required for transportation to the installation site 2, required lifting gear, required ballast gear, required lightning protection 65, and required surge protection 66. The ballast gear is required for some photovoltaic systems 6 to weight the solar panels 25 and the mounting system 62 such that they are secure even under high wind loads. The assembly instructions enable a quick and reliable creation of the photovoltaic system 6. For example, the processor 11 specifically calculates the volume and weight of materials to be transported to the construction site and selects a type of vehicle suitable for transporting the materials to the installations site 2.

In a variation, the assembly instructions comprise packing instructions for the list of components, such that the components and be quickly and efficiently packed into a vehicle for transportation, such as a truck. The processor 11 is configured to generate packing instructions which minimize the dead-space in the vehicle, the dead-space being the space between the components and other required gear.

In a variation, the generated list of components and/or the assembly instructions are added onto the solar panel report as described above. The list of components is used in the photovoltaic system warehouse to quickly create the photovoltaic system 6.

In a variation, the list of components and/or the assembly instructions are transmitted by the processor 11 to a warehouse server which automatically triggers an assembly order to create the photovoltaic system 11.

In Step 10, the photovoltaic system 6 is installed at the installation site 2. The list of components and/or the assembly instructions are used to install the photovoltaic system 6.

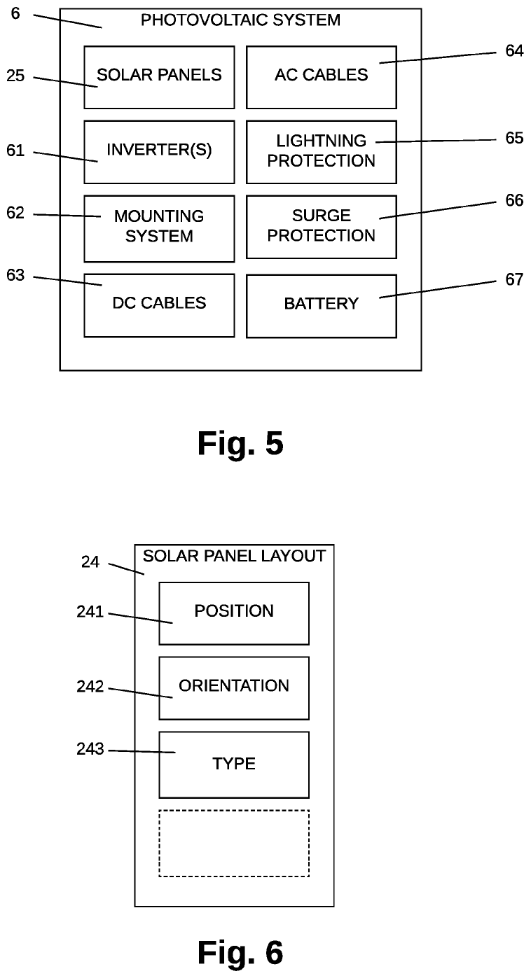

In FIG. 5, a number of components of the photovoltaic system 6 are shown. The photovoltaic system 6 comprises solar panels 25, one or more inverters 61, the mounting system 62, DC cables 63, AC cables 64, lightning protection 65, surge protection 66, and one or more batteries 67.

In FIG. 6, the solar panel layout 24 is shown comprising the position 241, the orientation 242, and the solar panel type 243 of each solar panel 25 of the solar panel layout 24.

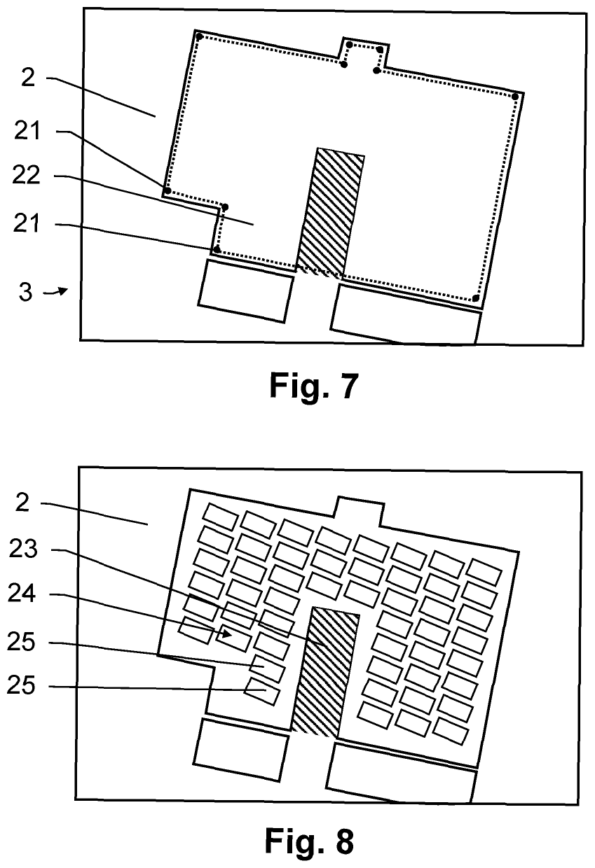

In FIG. 7, the image 3 depicting a plan view of the installation site 2 is shown. A multi-story building is shown with a flat roof. Several image coordinates 21 are shown which define an installation area 22.

In FIG. 8, the image 3 depicting a plan view of the installation site 2 is shown. The generated solar panel layout 24 is shown as a square lattice covering the installation area 22, except for the restricted area 23. The solar panels 25 of the solar panel layout 24 are rectangular and arranged in a lattice. The arrangement in a lattice allows for a high installed capacity, electrical production over a year, and high relative electrical production. The axes of the lattice of the solar panel layout 24 do not line up with the edge of the installation area 23 precisely, as the slight angular offset allows the solar panels 25 to better face the sun and therefore improves the electrical production of the photovoltaic system 6.

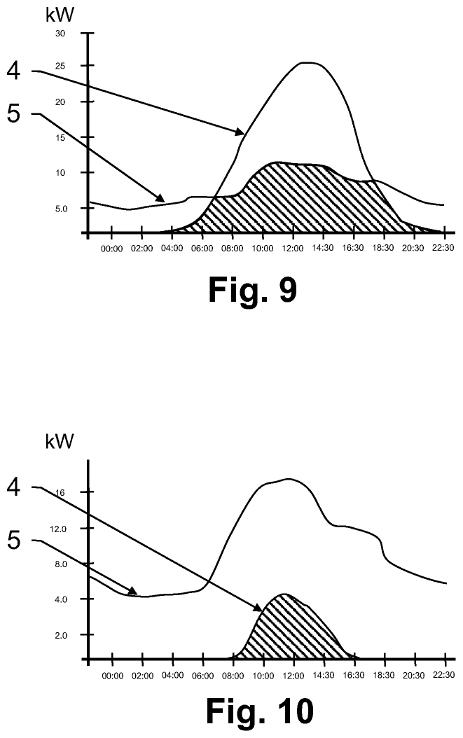

FIG. 9 shows a plot of the electrical production 4 of the photovoltaic system 6 during a typical summer day. The plot further shows the electrical consumption 5 at the installation site 2 during the same time period. It can be seen that the electrical production during the day follows a partially sinusoidal shape, and that during the middle of the day, i.e. between the hours of 12:00 and 14:00, the photovoltaic system 6 generates over 25 kW of electricity, providing more than the electrical consumption 5.

FIG. 10 shows a plot of the electrical production 4 of the photovoltaic system 6 during a typical winter day. The plot further shows the electrical consumption 5 at the installation site 2 during the same time period. As in FIG. 9, the electrical production of the photovoltaic system 6 follows a partially sinusoidal shape. It can be seen that, even during midday, the electrical production 4 of the photovoltaic system 6 is not sufficient to cover the electrical consumption 5 at the installation site 2.

LIST OF DESIGNATIONS

| | | | |
|---|---|---|---|
| 1 | Computer | 25 | Solar Panels |
| 11 | Processor | 3 | Image |
| 12 | Memory | 4 | Electrical Production |
| 13 | Communication Interface | 5 | Installation Site Electrical |
| 14 | Display | | Consumption |
| 15 | Input Device | 6 | Photovoltaic System |
| 2 | Installation Site | 61 | Inverter |
| 21 | Image Coordinates | 62 | Mounting System |
| 22 | Installation Area | 63 | DC Cables |
| 23 | Restricted Area | 64 | AC Cables |
| 24 | Solar Panel Layout | 65 | Lightning Protection |
| 241 | Solar Panel Position | 66 | Surge Protection |
| 242 | Solar Panel Orientation | 67 | Battery |
| 243 | Solar Panel Type | | |

1. A method for creating a photovoltaic system comprising several interconnected solar panels, the method comprising:
a. generating, by a processor, an image of an installation site of the photovoltaic system and displaying the image on a display;
b. receiving, in the processor, from a user, image coordinates corresponding to points on the image;
c. defining, in the processor, an installation area (22) of the solar panels using the image coordinates;
d. receiving, in the processor, site-specific data of the installation site and solar panel specification data of one or more types of solar panels; and
e. generating, in the processor, a solar panel layout of the solar panels within the installation area using the installation area, the site-specific data, and solar panel specification data, the solar panel layout comprising one or more of: a position of each solar panel, a solar panel orientation of each solar panel and the type of each solar panel.

2. The method of claim 1, further comprising simulating, in the processor, the photovoltaic system using the solar panel layout and site-specific data.

3. The method of claim 2, wherein simulating the photovoltaic system comprises simulating one or more of: an installed capacity, an electrical production within a given time interval, and a relative electrical production.

4. The method of claim 2, wherein simulating the photovoltaic system further comprises optimizing, in the processor, the photovoltaic system by iteratively first generating an adjusted solar panel layout and secondly simulating the adjusted solar panel layout, until an optimum is reached in one or more of: an installed capacity, an electrical production within a given time interval, and a relative electrical production.

5. The method of claim 2, wherein simulating the photovoltaic system further comprises:
a. receiving, in the processor, power usage data at the installation site, the power usage data comprising one or more of: a number of residents at the installation site and a number of kilowatt-hours of power used per year at the installation site; and
b. generating, in the processor, using the power usage data and the solar panel layout, one or more of: a proportion of yearly power provided by the photovoltaic system, draw power representing the power drawn per year at the installation site from a power grid, and feed power representing the power fed per year into the power grid by the photovoltaic system.

6. The method of claim 1, wherein generating the solar panel layout comprises generating a mounting system for mounting each of the solar panels.

7. The method of claim 1, wherein the solar panel specification data comprises one or more of: type, dimensions, weight, model, maximum power, module efficiency, maximum power point voltage, maximum power point current, operating temperature, and mounting system compatibility data.

8. The method of claim 1, wherein generating an image of the installation site comprises generating a plan view of the installation site using geolocation data.

9. The method of claim 1, wherein generating the solar panel layout comprises calculating, in the processor, one or more pitches of one or more sections of the installation site.

10. The method of claim 1, wherein generating the solar panel layout comprises calculating, in the processor, one or more of:
a. safety margins of the installation site,
b. wind load of the solar panel layout,
c. snow load of the solar panel layout, and
d. total weight of the solar panel layout.

11. The method of claim 1, wherein the site-specific data comprises one or more of:
a. a geographic location of the installation site;
b. solar irradiation data of the installation site,
c. site orientation data of the installation site;
d. topographic data of the installation site;
e. an environment type of the installation site;
f. a roof type of a building of the installation site;
g. a roof surface of the building of the installation site;
h. a height above sea level of the installation site;
i. a height above ground of the installation site;
j. solar paths at the installation site; and
k. shadowed areas at the installation site.

12. The method of claim 1, wherein creating the photovoltaic system further comprises generating, in the processor, a list of components of the photovoltaic system comprising one or more of:
a. a number of each type of solar panel,
b. a list of components of the mounting system,
c. an inverter type,
d. a battery type,
e. DC cable types and AC cable lengths, and
f. AC cable types and AC cable lengths.

13. The method of claim 1, wherein creating the photovoltaic system further comprises generating, in the processor, assembly instructions for the photovoltaic system at the installation site using the solar panel layout, the assembly instructions comprising a list of one or more of:
a. a number of meters of guardrail required,
b. volume of materials to be transported to the installation site,
c. weight of materials to be transported to the installation site,
d. type of vehicle required for transportation to the installation site,
e. required lifting gear,
f. required ballast gear,
g. required lightning protection, and
h. required surge protection.

14. The method of claim 1, further comprising creating the photovoltaic system, wherein creating the photovoltaic system comprises one or more of: installing and commissioning the photovoltaic system.

15. A photovoltaic system comprising several interconnected solar panels created according to the method of claim 1.

16. A computer for creating a photovoltaic system, the computer comprising a processor configured to carry out the method of claim 1.

17. A computer program product comprising a non-transitory computer-readable medium having stored thereon computer program code configured to control a processor of a computer such that the computer performs the steps according to the method of claim 1.
